(19) United States
(12) Patent Application Publication
(10) Pub. No.: US 2022/0151389 A1
(43) Pub. Date: May 19, 2022

(54) FOOTREST WITH INSULATED COMPARTMENT

(71) Applicant: Rayefield J. Turner, Grain Valley, MO (US)

(72) Inventor: Rayefield J. Turner, Grain Valley, MO (US)

(21) Appl. No.: 17/097,689

(22) Filed: Nov. 13, 2020

(51) Int. Cl. A47C 7/62; A47C 7/50; F25D 3/04; B65D 81/38

(52) U.S. Cl. CPC A47C 7/622; B65D 81/3813; F25D 3/045; A47C 7/50

(57) ABSTRACT

A footrest apparatus is formed by a base structure and a padded upper panel. The base structure has an insulated compartment therein with an insulated cover to keep articles cool or warm therein. A hinge mechanism connected between the base and panel releasably locks the panel in an upward position.

### BACKGROUND OF THE INVENTION

### Field of the Invention

The present invention is broadly concerned with footrest furniture and, more particularly, to such furniture having an insulated compartment or cooler provided therein.

### Background & Description of the Related Art

A footrest is a piece of furniture used to elevate the feet while sitting. A footrest may be alternatively known as a foot stool, an ottoman, or a hassock. A footrest is generally used to provide comfort to a person seated, for example, in a chair or sofa. It is typically a short, wide article of furniture. The top may be padded and upholstered or covered with a material such as leather, fabric, plastic, or a laminate of such materials. A footrest allows the seated person to rest their feet upon it, supporting the legs at a mostly horizontal level or at a somewhat elevated level.

Footrests, of various forms, have been known for many years, and have evolved throughout history. The ottoman was first designed as sectional furniture that wrapped around walls of a room, before evolving into smaller versions that fit into the corner of a room or functioned as padded seats. Eventually, the ottoman became a piece of furniture for resting the feet or legs upon. Because footrests are often hollow, box-like structures, some have been adapted for placing articles inside them, such as magazines, books, or the like. Such footrests may have at least one side open for access to articles within the interior thereof or have a hinged panel.

### SUMMARY OF THE INVENTION

The present invention provides embodiments of an improved footrest having an upper panel which can be releasably retained in a generally upstanding position and embodiments of a footrest having an insulated compartment therein.

An embodiment of the footrest includes a base structure configured for engaging a floor, the base having an upper base surface; an upper panel pivotally connected to the base structure to enable movement between a lower position in covering relation to the upper base surface and an upper position in which the upper panel is in substantially upstanding relation to the base structure; and a hinge mechanism pivotally connecting the upper panel to the base structure, the hinge mechanism being configured to releasably retain the upper panel in the upper position and to enable selective release of the hinge mechanism to pivot the upper panel to the lower position. The upper panel may having a pad or padding on an external or top surface thereof.

In embodiments of the footrest, the hinge mechanism includes: a base hinge bracket secured to the base structure; a panel hinge bracket secured to the upper panel; a pivot slot formed in only one of the base hinge bracket or the panel hinge bracket, the slot having a lock end and an opposite release end; a pivot member secured to the other of the panel hinge bracket or the base hinge bracket and extending through the pivot slot; and the panel hinge bracket cooperating with the base hinge bracket in such a manner that movement of the pivot member to the lock end of the slot prevents pivoting movement of the upper panel and movement of the pivot member to the release end of the slot enables pivoting movement of the upper panel.

More particularly, in an embodiment of the footrest of the present invention, the hinge mechanism includes: a pair of base hinge brackets secured to the base structure in laterally spaced and aligned relation; a pair of panel hinge brackets secured to the upper panel in laterally spaced and aligned relation; a respective pivot slot formed in each of the base hinge brackets, the pivot slots being mutually aligned and having lock ends and opposite release ends which are mutually aligned; a respective pivot member secured to each of the panel hinge brackets, the pivot members being aligned and extending through an associated base hinge bracket; and the panel hinge brackets cooperating with the base hinge brackets in such a manner that movement of the panel hinge brackets to engage the lock ends of the slots with the pivot members prevents pivoting movement of the upper panel and movement of the hinge brackets to engage the release ends of the slots with the pivot members enables pivoting movement of the upper panel. The footrest may include a spring secured to the base structure and to the upper panel, the spring resiliently urging the upper panel in such a direction as to engage the lock ends of the slots with the pivot members to thereby retain the upper panel in the upper position.

An embodiment of the footrest includes a thermally insulated compartment positioned within the base structure beneath the upper panel, the insulated compartment being configured to receive an article therein and to impede acclimation of the article to an ambient temperature external thereto. The insulated compartment may include: insulated walls joined to form an insulated container open on a top side and an insulated cover sized to removably cover the insulated container. The walls are preferably joined in such a manner that the insulated container is sealed to thereby contain liquids therein, such as water from melted ice. The footrest may include an access opening formed in an upper surface of the base structure to provide access to the insulated compartment; an access panel configured to be received in the access opening in covering relation to the insulated compartment. The access panel may include a handle to facilitate removing and replacing the access panel. The insulated compartment may be configured such that it is removable from the base structure of the footrest to enable emptying water from melted ice, for cleaning, or the like.

Various objects and advantages of the present invention will become apparent from the following description taken in conjunction with the accompanying drawings wherein are set forth, by way of illustration and example, certain embodiments of this invention.

The drawings constitute a part of this specification, include exemplary embodiments of the present invention, and illustrate various objects and features thereof.

### BRIEF DESCRIPTION OF THE DRAWINGS

FIG. 1 is a perspective view of a footrest apparatus according to the present invention with a padded upper panel shown in a lower position.

FIG. 2 is a perspective view of the footrest apparatus shown with the upper panel shown in a generally upstanding position.

FIG. 3 is a is a perspective view of the footrest apparatus shown with the upper panel in the upstanding position and with an access panel and a compartment lid shown removed to enable access to articles in an insulated compartment positioned within a base structure of the apparatus.

FIG. 4 is an enlarged fragmentary top plan view illustrating details of a hinge mechanism employed in the footrest apparatus of the present invention.

FIG. 5 is a further enlarged fragmentary side elevational view of the hinge mechanism, shown in a locked position.

FIG. 6 is a view similar to FIG. 5 and shows the hinge mechanism in a released position thereof.

### DETAILED DESCRIPTION OF THE PREFERRED EMBODIMENTS

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure

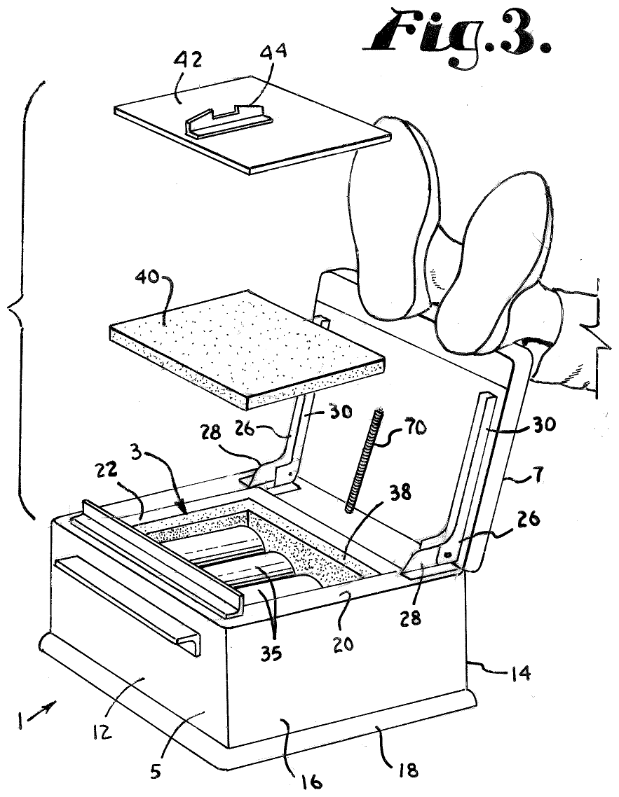

Referring to the drawings in more detail, the reference number 1 generally designates an embodiment of a footrest apparatus according to the present invention and having an insulated compartment 3 (FIG. 3) positioned within the apparatus. The apparatus 1 generally includes a base structure 5 and an upper panel 7 which is pivotally or hingedly connected to the base structure 5. The upper panel 7 may have a pad or padding 8 on an upper or outer surface thereof. The apparatus 1 may be alternatively referred to as a footstool, an ottoman, a hassock, or the like.

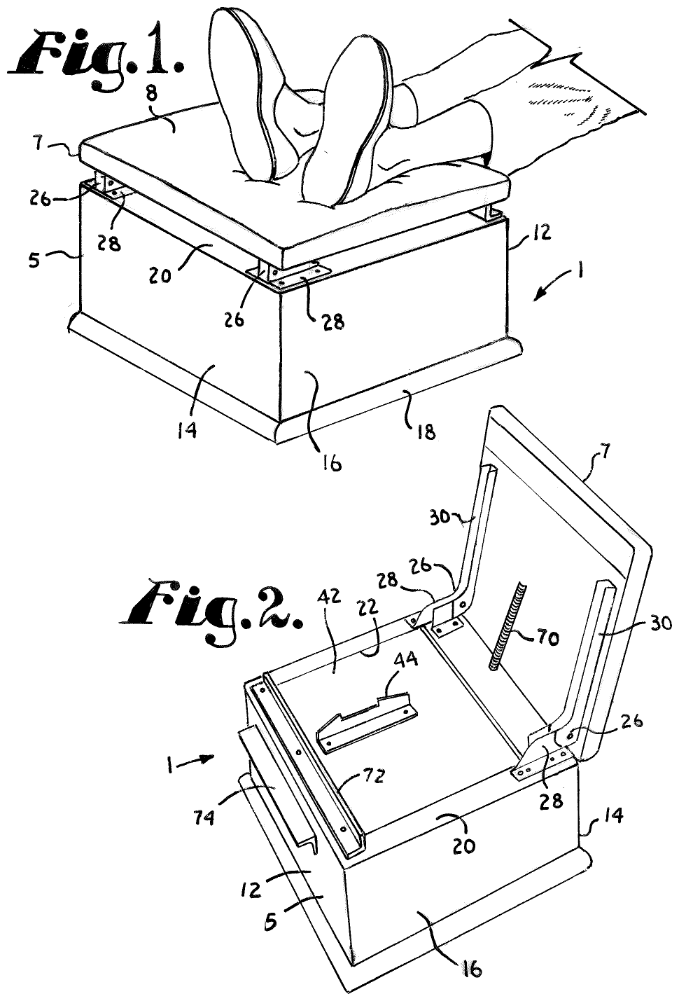

Referring to FIGS. 1-3, the illustrated base structure 5 may be a box-like frame formed by front and rear panels, 12 and 14 respectively, side panels 16, and a base panel 18 which closes the bottom of the base structure 5. External edges of the base panel 18 may be rounded off, as is illustrated. Outer surfaces of the panels 12, 14, and 16 may be provided with padding material (not shown). Similarly, exposed upper and side surfaces of the base panel 18 may also be provided with padding material (not shown). The illustrated base structure 5 includes an upper wall 20 having an access opening 22 formed therein, as will be described further below.

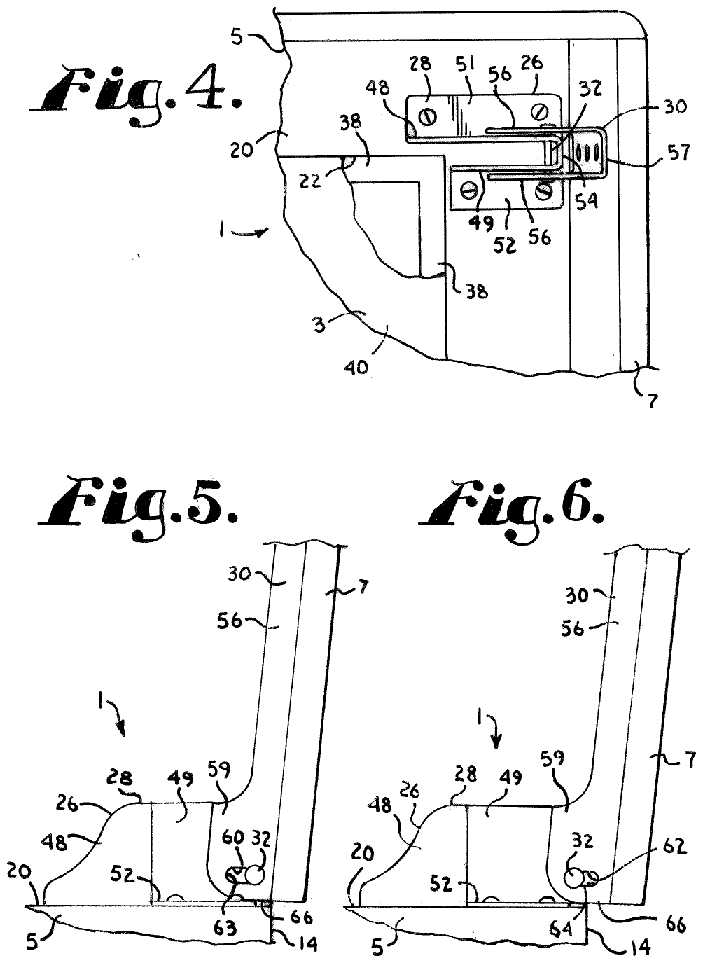

The upper panel 7 is hingedly connected to the base structure 5 by laterally spaced hinge mechanisms 26. Each hinge mechanism 26 includes a base hinge bracket 28 and an upper panel hinge bracket or panel hinge bracket 30. The base hinge brackets 28 are secured in laterally aligned relation to the upper wall 20 of the base structure 5 near the rear panel 14. Similarly, the panel hinge brackets 30 are secured to the upper panel 7 in laterally aligned relation. The panel hinge brackets 30 are pivotally connected to the respective base hinge brackets 28 by pivot members 32 (FIGS. 5 and 6). The hinge mechanisms 26 enable the upper panel 7 to be placed in a downward or closed position, as shown in FIG. 1, or in an upward or open position, as shown in FIGS. 2 and 3.

Referring to FIG. 3, the base structure 5 of the apparatus 1 has the insulated compartment 3 positioned therein to receive articles 35 and to impede acclimation of the articles to an ambient temperature external thereto. For example, if the articles 35 are cooled canned beverages, the insulated compartment 3 keeps them cool. It is foreseen that the insulated compartment 3 could also be used to slow the cooling of warmed articles 35. The illustrated insulated compartment or container 3 is formed by compartment walls 38 joined to form a rectangular compartment with a closed bottom (not shown). A removable insulated cover 40 is provided to close a top side of the compartment 3 to maintain the internal temperature of the compartment 3. The walls 38 and cover 40 may be made of an insulating material such as a somewhat rigid foam polymer.

Preferably, the walls 38 are joined in such a manner that the compartment 3 is waterproof to enable the use of ice to cool the articles 35 if desired. The illustrated compartment 3 is accessible through the access opening 22 of the base structure 5. The access opening 22 may be closed by a removable access panel 42 which may be provided with a handle 44 to facilitate handling of the access panel 42. The insulated compartment 3 is preferably selectively removable from the base structure 5 to allow periodic cleaning of the interior of the compartment 3 or to empty water from melted ice within the compartment.

The legs or feet of a user may be rested on the upper panel 7 in the lower position shown in FIG. 1 or in the upper position shown in FIG. 3. It is desirable for the upper panel 7 to be locked in the upper position when it is to be used as a footrest and at other times. The illustrated hinge mechanisms 26 are configured to enable the upper panel 7 to be locked in the upper position and conveniently released to pivot the panel 7 to the lower position.

Referring to FIGS. 4-6, the illustrated base hinge bracket 28 is generally U-shaped as viewed in FIG. 4 and has outer and inner webs 48 and 49 upstanding from respective outer and inner mounting flanges 51 and 52. The webs 48 and 49 are connected by a rear web 54. The base hinge bracket 28 is secured to the upper wall 20 of the base structure 5, as by fasteners such as screws passing through the flanges 51 and 52. Depending on the position of the bracket 28 in relation to the access opening 22, the inner web 49 and flange 52 are shortened to avoid interference with the assess opening 22.

The illustrated panel hinge brackets 30 are elongated members which are U-shaped in cross section and include side webs 56 connected by an end web 57. Lower or rear ends 59 of the side webs 56 are enlarged and have pivot slots 61 formed therethrough. The lower web ends 59 of the panel hinge brackets 30 are spaced apart so that they engage outer surfaces of the webs 48 and 49 of the base hinge brackets 28. The panel hinge brackets 30 are pivotally connected to the base hinge brackets 28 by the pivot pins 32 passing through the slots 61 of the lower web ends 59 and through holes (not shown) formed through the webs 48 and 49. The illustrated pivot pins 32 have heads at opposite ends thereof.

The pivot slots 61 are positioned in a substantially horizontal orientation when the upper panel 7 is in the upward position shown in FIGS. 5 and 6. Each of the illustrated slots 61 has a release end 63 spaced away from the upper panel 7 and a lock end 64 positioned close to the upper panel 7. When the upper panel 7 is in a released position with the release ends 63 engaging the pivot pins 32 (FIG. 6), the upper panel 7 may be freely pivoted toward the closed position (FIG. 1). However, when the upper panel 7 is positioned so that the lock ends 64 of the slots 61 engage the pivot pins 32 (FIG. 5), engagement of flat edges 66 of the lower ends 59 of the side webs 56 with the flanges 51 and 52 of the base hinge bracket 28 prevents pivoting movement of the upper panel 7. The upper panel 7 may be released to pivot by moving it in such a manner that the release ends 64 of the slots 61 engage the pivot pins 32. It is foreseen that embodiments of the apparatus 1 could be configured so that the slots 61 are formed through the webs 48 and 49 of the base hinge bracket 26 rather than the ends 59 of the side webs 56 of the panel hinge brackets 30 and with the pivot pins 32 mounted stationary relative to the web ends 59.

The apparatus 1 may have a tension spring 70 connected between the upper panel 7 and the upper wall 20 of the base structure 5 which resiliently urges the upper panel 7 toward the locked position (FIG. 5). The apparatus 1 may include a spacer bracket 72 (FIG. 2) positioned on the upper wall 20 near the front panel 12 that the upper panel 7 engages when folded down. Additionally, a handle bracket 74 may be provided on the front panel 12 of the base structure 5 to facilitate lifting the apparatus 1. A similar bracket may be provided on the rear panel 14.

However, the hinge mechanisms 26 may form a space between an inner end of the upper panel 7 and the rear panel 14 which may provide a grip on a rear side of the base structure 5.

It is to be understood that while certain forms of the present invention have been illustrated and described herein, it is not to be limited to the specific forms or arrangement of parts described and shown.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. A footrest apparatus comprising:
(a) a base structure configured for engaging a floor, the base having an upper base surface;
(b) an upper panel pivotally connected to the base structure to enable movement between a lower position in covering relation to the upper base surface and an upper position in which the upper panel is in substantially upstanding relation to the base structure, the upper panel having padding on an external surface thereof; a top surface of the upper panel being substantially horizontal in a lower footrest configuration and being substantially vertical in a upper footrest configuration;
(c) a hinge mechanism pivotally connecting the upper panel to the base structure, the hinge mechanism being configured to releasably retain the upper panel in the upper position and to enable selective release of the hinge mechanism to pivot the upper panel to the lower position;
(d) the hinge mechanism including a pair of base hinge brackets secured to the base structure in laterally spaced and aligned relation;
(e) a pair of panel hinge brackets secured to the upper panel in laterally spaced and aligned relation;
(f) a respective pivot slot formed in each of the base hinge brackets, the pivot slots being mutually aligned and having lock ends and opposite release ends which are mutually aligned; each of the pivot slots including a release end spaced forward of the upper panel and a lock end between a respective release end and the upper panel;
(g) a respective pivot member secured to each of the panel hinge brackets, the pivot members being aligned and extending through an associated base hinge bracket and being slidable by manipulation of a user between respective release and lock ends of a respective slot;
(h) the panel hinge brackets cooperating with the base hinge brackets in such a manner that movement of the panel hinge brackets to engage the lock ends of the slots with the pivot members prevents pivoting movement of the upper panel and movement of the hinge brackets to engage the release ends of the slots with the pivot members enables pivoting movement of the upper panel; the upper panel being positioned in the lower foot rest configuration when the pivot members engage respective release ends of respective slots and also being in the upper foot rest configuration when respective pivot members engage respective lock ends; and
(i) a thermally insulated compartment removably positioned within the base structure beneath the upper panel, the insulated compartment being configured to receive articles therein and to impede acclimation of the articles to an ambient temperature external thereto.

16. (canceled)

17. An apparatus as set forth in claim 15 and including:
(a) a spring secured to the base structure and to the upper panel, the spring resiliently urging the upper panel in such a direction as to position the pivot members at the lock ends of the slots to thereby retain the upper panel in the upper position.

18. An apparatus as set forth in claim 15 wherein the insulated compartment includes:
(a) insulated walls joined to form an insulated container open on a top side thereof; and
(b) a fully removable insulated cover sized to removably cover the insulated container and join with the container to form an enclosed insulated box for holding food.

19. An apparatus as set forth in claim 15 and including:
(a) an access opening formed in an upper surface of the base structure to provide access to the insulated compartment; and
(b) an access panel configured to be received in the access opening in covering relation to the insulated compartment.

20. An apparatus as set forth in claim 15 wherein:
(a) the upper panel has padding on an external surface thereof.
